(19) United States
(12) Patent Application Publication
(10) Pub. No.: US 2024/0359462 A1
(43) Pub. Date: Oct. 31, 2024

(54) LIQUID DROPLET EJECTING HEAD

(71) Applicant: BROTHER KOGYO KABUSHIKI KAISHA, Nagoya (JP)

(72) Inventors: TAKAAKI YOSHINO, Nagoya (JP); TORU KAKIUCHI, Chita (JP); TAISUKE MIZUNO, Yokkaichi (JP)

(73) Assignee: BROTHER KOGYO KABUSHIKI KAISHA, Nagoya (JP)

(21) Appl. No.: 18/628,900

(22) Filed: Apr. 8, 2024

(30) Foreign Application Priority Data
Apr. 28, 2023 (JP) 2023-074139

(51) Int. Cl. B41J 2/14

(52) U.S. Cl. CPC B41J 2/14233; B41J 2202/11

(57) ABSTRACT

There is provided a liquid droplet ejecting head including: a channel member having a channel which includes a nozzle and a pressure chamber communicating with the nozzle; and a piezoelectric element arranged on the channel member and configured to apply a pressure to a liquid inside the pressure chamber to eject a liquid droplet of the liquid from the nozzle. A diameter D [μm] of the nozzle and a natural frequency Fr [kHz] of the channel satisfy Expressions 1 and 2 as follows: Expression 1: D≤−2.25×10⁻⁸×Fr⁴+2.11×10⁻⁵×Fr³−7.60×10⁻³×Fr²+1.32×Fr−62.9, Expression 2: D≥0.050×Fr+8.5.

### REFERENCE TO RELATED APPLICATIONS

This application claims priority from Japanese Patent Application No. 2023-074139 filed on Apr. 28, 2023. The entire content of the priority application is incorporated herein by reference.

### BACKGROUND ART

Conventionally, there is a known ink-jet head having an ink channel. The ink channel includes a nozzle, a pressure chamber communicating with the nozzle, and a piezoelectric actuator (piezoelectric element). In a certain known ink-jet head, the piezoelectric actuator generates a pressure in the inside of the pressure chamber to thereby eject a liquid droplet of a liquid from the nozzle.

In order to realize a high-speed recording in a liquid droplet ejecting head, generally, it is necessary to eject the liquid droplet in an amount sufficient for the recording at a high driving frequency. The certain known ink-jet head as described above focuses on an influence of a pressure resonance generated in the inside of the pressure chamber and adopts a method of increasing a driving frequency.

### SUMMARY

In a case that the driving frequency is a high frequency which is 50 kHz or more, however, before the tail of a preceding liquid droplet is separated from the meniscus of a nozzle, a succeeding liquid droplet is ejected. As a result, there is provided a state that the succeeding liquid droplet is linked to the tail of the preceding liquid droplet.

In order to prevent the occurrence of such a linkage of the liquid droplets as described above, it is preferred to shorten a pinch-off-time. The pinch-off time is a time from a point of time at which a driving signal regarding ejection of a liquid droplet is applied to the piezoelectric element and until a point of time at which a tail of this ink droplet is separated from the meniscus of the nozzle. The inventors of the present disclosure found out that reducing the diameter of the nozzle and increasing a natural frequency of a channel are effective as a means of shortening the pinch-off-time.

In a case that the diameter of the nozzle is made small, however, the amount of the liquid droplet ejected from the nozzle is reduced, and thus it is not possible to eject the liquid droplet in the amount sufficient for the recording.

Further, in order to increase the natural frequency of the channel, it is necessary to make the rigidity of the piezoelectric element great. In a case that the rigidity of the piezoelectric element is great, a large energy is required for deforming the piezoelectric element so as to eject a liquid droplet in a desired amount. In order to maintain the durability of the piezoelectric element, it is desirable to apply a large energy, which would exceed a predetermined value, to the piezoelectric element. Accordingly, the magnitude of the energy to be applied to the piezoelectric element becomes to be insufficient, and thus it is not possible to eject the liquid droplet in the sufficient amount for the recording.

An object of the present disclosure is to provide a liquid droplet ejecting head configured to eject liquid droplets in an amount sufficient for the recording, at a high driving frequency.

According to an aspect of the present disclosure, there is provided a liquid droplet ejecting head including: a channel member including a channel including a nozzle and a pressure chamber communicating with the nozzle; and a piezoelectric element arranged on the channel member and configured to apply a pressure to a liquid inside the pressure chamber to eject liquid droplets of the liquid from the nozzle, wherein a diameter D [μm] of the nozzle and a natural frequency Fr [kHz] of the channel satisfy Expressions 1 and 2 as follows: Expression 1: D≤−2.25×10⁻⁸×Fr⁴+2.11×10⁻⁵×Fr³−7.60×10⁻³×Fr²+1.32×Fr−62.9, Expression 2: D≥0.050×Fr+8.5.

### BRIEF DESCRIPTION OF DRAWINGS

FIG. 1 is a plan view of a printer 100 including a head 1.

FIG. 2 is a block diagram depicting the electric configuration of the printer 100.

FIG. 3 is a plan view of the head 1.

FIG. 4 is a cross-sectional view of the head 1 taken along a IV-IV line of FIG. 3.

FIG. 5 is a graph indicating a relationship among a diameter D of a nozzle, a natural frequency Fr of an individual channel and a pinch-off-time.

FIG. 6 is a graph indicating a relationship among the diameter D of the nozzle, the natural frequency Fr of the individual channel and an amount V of an ink droplet.

FIG. 7 is a plan view of a head 201.

### DESCRIPTION

### First Embodiment

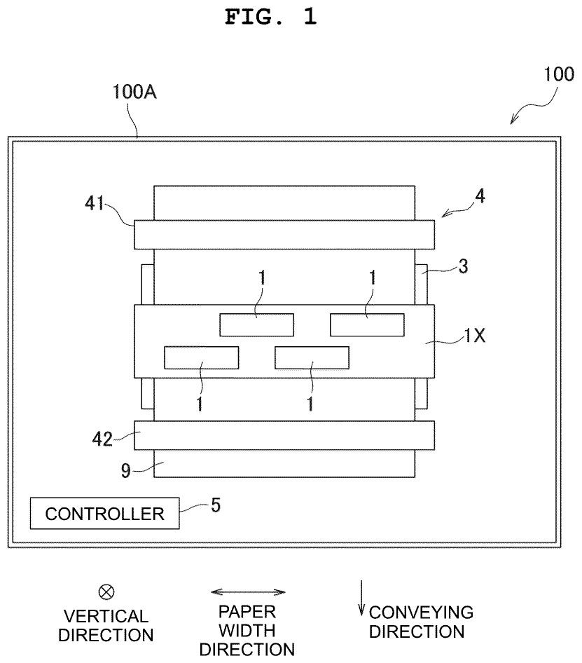

A head 1 according to a first embodiment of the present disclosure is included in a printer 100. The printer 100 is provided with a casing 100A, a head unit 1X including four heads 1, a platen 3, a conveyor 4 and a controller 5, as depicted in FIG. 1. The head unit 1X, the platen 3, the conveyor 4 and the controller 5 are arranged in the inside of the casing 100A.

A length in a paper width direction of the head unit 1X is longer than a length in a conveying direction of the head unit 1X. The paper width direction is a direction along a width of a paper sheet 9 (paper 9, sheet 9) and is orthogonal to the conveying direction and the vertical direction. The head unit 1X is fixed to the casing 100A. The kind of the head unit 1X is a line system.

In the head unit 1X, the four heads 1 are arranged in a staggered manner in the paper width direction. A length in the paper width direction of the head 1 is longer than a length in the conveying direction of the head 1.

The platen 3 is a plate along a plane orthogonal to the vertical direction, and is arranged at a location below the head unit 1X. The paper sheet 9 is supported on the upper surface of the platen 3.

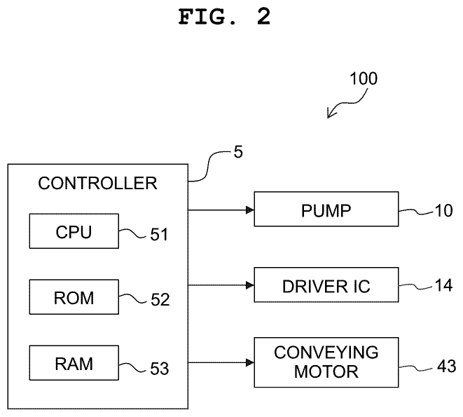

The conveyor 4 includes a roller pair 41 having two rollers, a roller pair 42 having two rollers and a conveying motor 43 as depicted in FIG. 2. In the conveying direction, the head unit 1X and the platen 3 are arranged between the roller pair 41 and the roller pair 42.

In a case that the conveying motor 43 (see FIG. 2) is driven by a control of the controller 5, the rollers of the roller pairs 41 and 42 rotate. By the rotations of the rollers of the roller pairs 41 and 42, the paper sheet 9, which is pinched or held by the rollers of the roller pairs 41 and 42, is conveyed in the conveying direction.

The controller 5 includes a CPU 51, a ROM 52 and a RAM 53 as depicted in FIG. 2.

The CPU 51 executes a variety of kinds of control based on data inputted from an external apparatus or device and in accordance with a program and data stored in the ROM 52 and the RAM 53. The external apparatus is, for example, a personal computer (PC).

The program and the data by which the CPU 51 performs the variety of kinds of control are stored in the ROM 52. The RAM 53 temporarily stores data used by the CPU 51 in a case that the CPU 51 executes a program.

Next, the configuration of the head 1 will be explained.

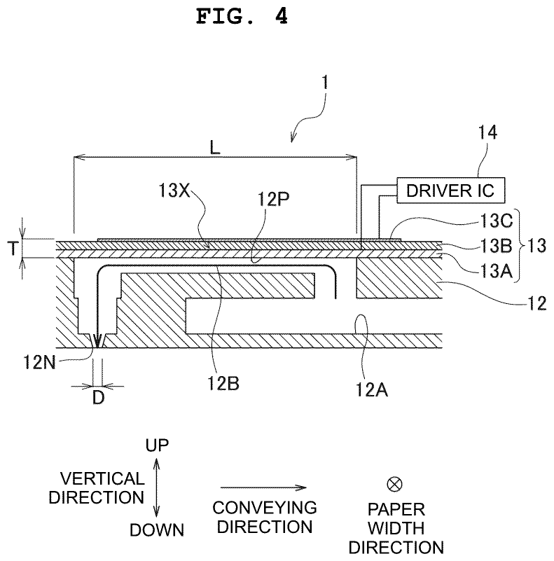

As depicted in FIG. 4, the head 1 includes a channel member 12 and an actuator member 13.

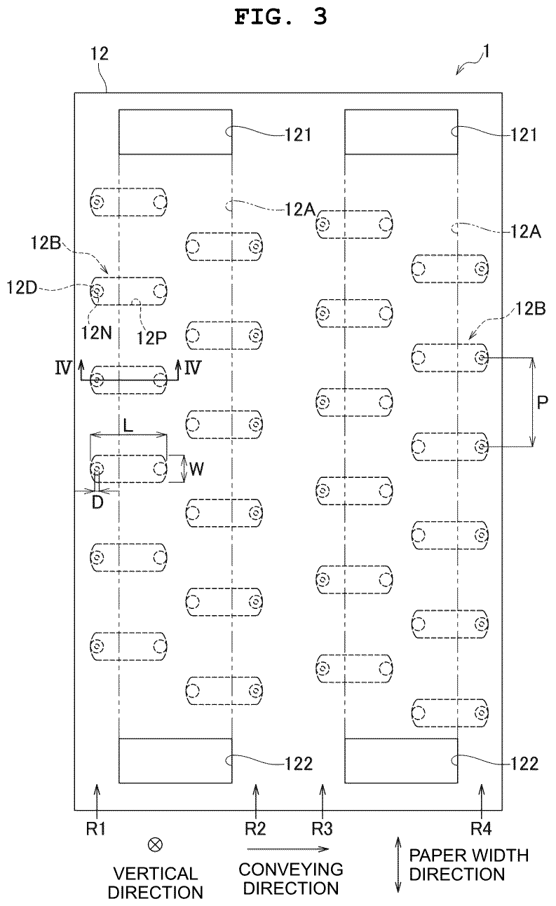

As depicted in FIG. 3, two supply ports 121 and two return ports 122 are opened in an upper surface of the channel member 12. The two supply ports 121 are arranged at one end in the paper width direction in the channel member 12. The two return ports 122 are arranged at the other end in the paper width direction in the channel member 12. Each of the two supply ports 121 and the two return ports 122 is communicated with an ink tank (not depicted) via a tube (not depicted).

The channel member 12 has two common channels 12A and a plurality of individual channels 12B.

The two common channels 12A are arranged side by side in the conveying direction and each extend in the paper width direction. Each of the two supply ports 121 is connected to one end in the paper width direction in one of the two common channels 12A, and each of the two return ports 122 is connected to the other end in the paper width direction in one of the two common channels 12A. Each of the two common channels 12A communicates with the ink tank via one of the two supply ports 121 and one of the two return ports 122, and communicates with the plurality of individual channels 12B.

Each of the plurality of individual channels 12B includes a nozzle 12N and a pressure chamber 12P communicating with the nozzle 12N. The individual channel(s) 12B correspond(s) to a “channel” of the present disclosure.

A plurality of nozzles 12N is opened in the lower surface of the channel member 12, and a plurality of pressure chambers 12P is opened in the upper surface of the channel member 12. In a plane orthogonal to the vertical direction, the opening of the nozzle 12N is circular, and the opening of the pressure chamber 12P is substantially rectangular.

A diameter D of the nozzle 12N is 25 μm or less. A width W of the pressure chamber 12P is 70 μm or less. A length L of the pressure chamber 12P is 550 μm or less. The width W is a length in the paper width direction, and the length L is a length in the conveying direction.

As depicted in FIG. 3, the plurality of nozzles 12N are arranged in a staggered manner in the paper width direction and construct four nozzle rows (nozzle arrays) R1 to R4. Each of the nozzle rows R1 to R4 is constructed of nozzles 12N, of the plurality of nozzles 12N, which are aligned in the paper width direction.

In each of the nozzle rows R1 to R4, the nozzles 12N are arranged in the paper width direction at a pitch P which is 300 dpi or more. In the present embodiment, a recording resolution in each of the nozzle rows R1 to R4 is 300 dpi, and the pitch P is approximately 84 μm in each of the nozzle rows R1 to R4. The term “recording resolution” means a resolution of an image which is (to be) recorded by droplets of the ink ejected from the nozzles 12N.

In two nozzle rows, among the four nozzle rows R1 to R4, which are adjacent to each other in the conveying direction, the positions of the nozzles 12N in the paper width direction are shifted by half the pitch P. With this, in a case that the recording resolution in each of the nozzle rows R1 to R4 is 300 dpi, a recording resolution of 1200 dpi is realized by the four nozzle rows R1 to R4. The head 1 of the present embodiment has a recording resolution of 1200 dpi×1200 dpi in the paper width direction and the conveying direction.

In case that a pump 10 as depicted in FIG. 2 is driven by a control of the controller 5, the ink inside the ink tank is thereby supplied to each of the two common channels 12A via one of the two supply ports 121, and is distributed from each of the two common channels 12A to the plurality of individual channels 12B.

In a case that a piezoelectric element 13X (to be described later on) is driven so as to reduce the volume of the pressure chamber 12P, a pressure is thereby applied to the ink in the inside of each of the plurality of individual channels 12B. The ink to which the pressure is applied is ejected, as an ink droplet, from the nozzle 12N.

The ink (a part or portion of the ink) supplied to each of the two common channels 12A via one of the two supply ports 121 but not distributed to the individual channels 12B returns to the ink tank via one of the two return ports 122.

As depicted in FIG. 4, the actuator member 13 is fixed to the upper surface of the channel member 12. The actuator member 13 includes a vibration plate 13A made of a metal, a piezoelectric layer 13B and a plurality of individual electrodes 13C.

Parts, in the actuator member 13, each of which overlaps with the pressure chamber 12P in the vertical direction, function as piezoelectric elements 13X. The piezoelectric elements 13X are independently deformable in accordance with a potential applied to the plurality of individual electrodes 13C each of which corresponds to one of the piezoelectric elements 13X.

Each of the piezoelectric elements 13X is a thin film piezoelectric element. The thin film piezoelectric element is a so-called micro electro mechanical systems (MEMS). The piezoelectric elements 13X are formed by performing film formation sequentially, on the upper surface of the vibration plate 13A, of a thin film which is to be the piezoelectric layer 13B and a thin film which is to be the plurality of individual electrodes 13C. A thickness T of the thin film piezoelectric element is 1.5 μm or less.

The vibration plate 13A is arranged on the upper surface of the channel member 12 so as to cover the plurality of pressure chambers 12P. The piezoelectric layer 13B is arranged on the upper surface of the vibration plate 13A. Each of the plurality of individual electrodes 13C is arranged on the upper surface of the piezoelectric layer 13B so as to overlap, in the vertical direction, with a pressure chamber 12P, of the plurality of pressure chambers 12P, corresponding thereto.

The vibration plate 13A and the plurality of individual electrodes 13C are electrically connected to a driver IC 14. The driver IC 14 maintains a potential of the vibration plate 13A at the ground potential, whereas the driver IC 14 changes the potential of each of the plurality of individual electrodes 13C. The vibration plate 13A functions as a common electrode which is an electrode common to the plurality of piezoelectric elements 13X.

The driver IC 14 generates a driving signal based on a control signal from the controller 5 and supplies the driving signal to each of the plurality of individual electrodes 13C. The driving signal changes the potential of each of the plurality of individual electrodes 13C between a predetermined driving potential and the ground potential.

Next, an explanation will be given about an analysis performed by the inventors of the present disclosure.

### [First Analysis]

The inventors of the present disclosure prepared a plurality of analytic models of a plurality of heads 1 which were mutually different in view of the diameter D of the nozzle 12N, the width W of the pressure chamber 12P and the length L of the pressure chamber 12P, and caused the ink to be ejected from the nozzle 12N in each of the analytic models and thereby obtained a pinch-off-time. The pinch-off-time is a time from a point of time at which the driving signal is applied to the piezoelectric element 13X and until a point of time at which a tail of the ink droplet is separated from the meniscus of the nozzle 12N.

The width W of the pressure chamber 12P, the length L of the pressure chamber 12P and the diameter D of the nozzle 12N influence the natural frequency Fr. Accordingly, in the plurality of analytic models, there are various natural frequencies Fr. Note that the configuration, of the individual channel 12B, which is different from the width W of the pressure chamber 12P, the length L of the pressure chamber 12P and the diameter D of the nozzle 12N, is same among the plurality of analytic models.

From the result of the above-described analysis, the inventors of the present disclosure derived a sensitivity of the pinch-off-time with respect to the diameter D of the nozzle 12N and a sensitivity of the pinch-off-time with respect to the natural frequency Fr of the individual channel 12B, and further obtained a relationship among the diameter D of the nozzle 12N, the natural frequency Fr of the individual channel 12B and the pinch-off-time from these sensitivities.

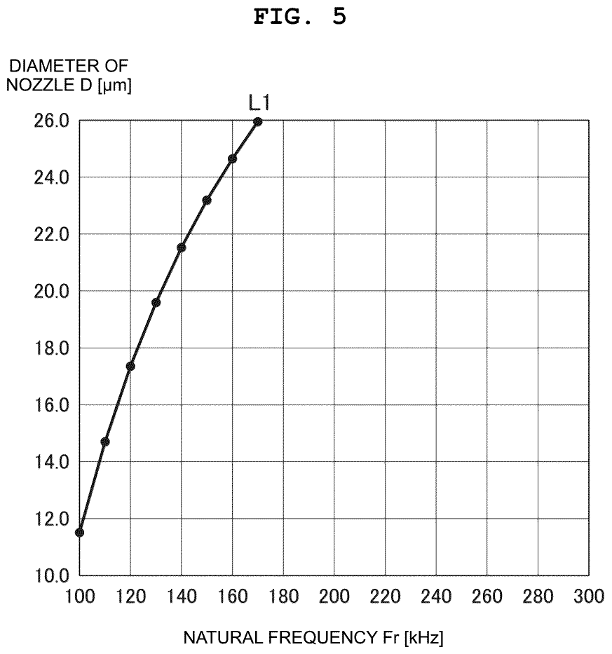

FIG. 5 indicates the result of the analysis. In FIG. 5, a curve L1 is obtained by connecting a plurality of plots indicating combinations, of the diameter D of the nozzle 12N and the natural frequency Fr of the individual channel 12B, each of which coincides with the pinch-off-time at a driving frequency of 50 kHz, and corresponds to an expression of the diameter D [μm] of the nozzle 12N and the natural frequency Fr [kHz] of the individual channel 12B: “D=−2.25×10⁻⁸×Fr⁴+2.11×10⁻⁵×Fr³−7.60×10⁻³×Fr²+1.32×Fr−62.9”. An area in FIG. 5 which is below the curve L1 is a range in which the pinch-off-time becomes further shorter.

In view of the above result, in the present embodiment, the head 1 is configured so that the diameter D [μm] of the nozzle 12N and the natural frequency Fr [kHz] of the individual channel 12B satisfy Expression 1 as follows. By causing the diameter D [μm] of the nozzle 12N and the natural frequency Fr [kHz] of the individual channel 12B to satisfy Expression 1, it is possible to eject the ink droplet stably. The phrase that “eject the ink droplet stably” (or “the ink droplet is ejected stably”, etc.) means that the tail of an ink droplet is separated from the meniscus of the nozzle 12N and then a next ink droplet is ejected, whereby any linking of ink droplets is not caused.

$$D \leq - 2.25 \times 1 {0}^{- 8} \times {Fr}^{4} + 2.11 \times 1 {0}^{- 5} \times {Fr}^{3} - 7.6 \times 1 {0}^{- 3} \times {Fr}^{2} + 1.32 \times Fr - 62. 9 \qquad Expression 1$$

### [Second Analysis]

The inventors of the present disclosure obtained a natural frequency Fr of the individual channel 12B and an amount V of the ink droplet with respect to a plurality of analytic models of a plurality of heads 1 which were mutually different in view of the diameter D of the nozzle 12N, the width W of the pressure chamber 12P and the length L of the pressure chamber 12P.

The width W of the pressure chamber 12P, the length L of the pressure chamber 12P and the diameter D of the nozzle 12N influence the natural frequency Fr. Accordingly, in the plurality of analytic models, there are various natural frequencies Fr. Note that the configuration, of the individual channel 12B, which is different from the width W of the pressure chamber 12P, the length L of the pressure chamber 12P and the diameter D of the nozzle 12N, is same among the plurality of analytic models.

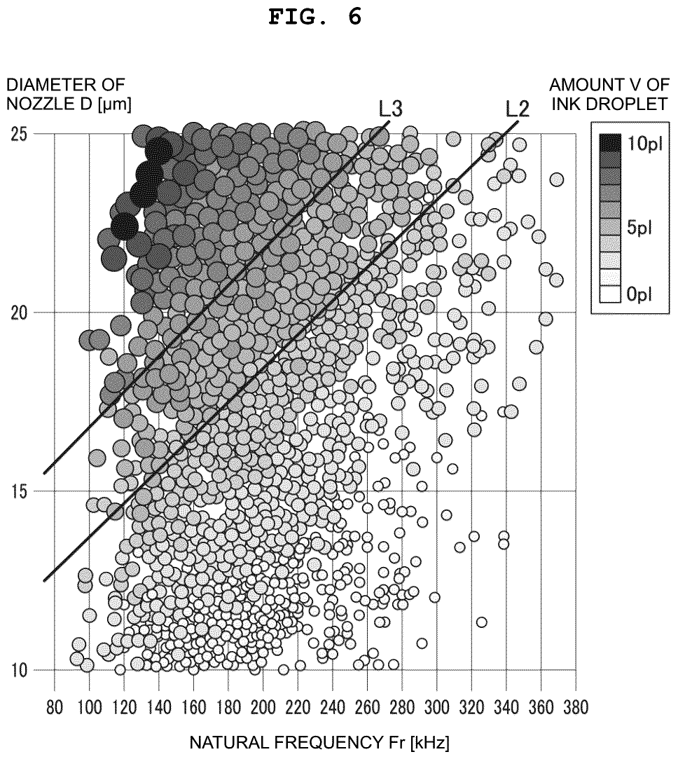

FIG. 6 indicates the result of the analysis by the above-described analytic models. FIG. 6 is a graph in which the amount V of the ink droplet ejected by applying the driving signal to the piezoelectric element 13X in each of the analytic models is plotted in a gray scale. In the plurality of analytic models, the driving potential was adjusted so that an ejecting velocity of the ink droplet became to be same among the plurality of analytic models.

A pulse width of a pulse included in the driving signal is equal to an Acoustic Length (AL). The term “AL” is one way propagation time of a pressure wave in the individual channel 12B. Since the plurality of analytic models are mutually different in the configuration of the individual channel 12B, the AL are mutually different among the plurality of analytic models. Therefore, the pulse width was made different per each of the plurality of analytic models.

It is appreciated from FIG. 6 that as the natural frequency Fr is higher, the amount V of the ink droplet is smaller. Further, it is also appreciated that as the diameter D of the nozzle 12N is smaller, the amount V of the ink droplet is smaller.

In the present embodiment, the recording resolution is made to be 1200 dpi or more. In order to record an image of satisfactory quality in this recording resolution, it is required to eject an ink droplet of which amount is approximately 4 pl.

In FIG. 6, an area in FIG. 6 which is above a straight line L2 is a range in which the amount V of the ink droplet is 4 pl or more, and an area in FIG. 6 which is above a straight line L3 is a range in which the amount V of the ink droplet is 6 pl or more. The straight L2 corresponds to an expression of the diameter D [μm] of the nozzle 12N and the natural frequency Fr [kHz] of the individual channel 12B: “D=0.050×Fr+8.5”. The straight L3 corresponds to an expression of the diameter D [μm] of the nozzle 12N and the natural frequency Fr [kHz] of the individual channel 12B: “D=0.055×Fr+11.5”.

In view of the above result, in the present embodiment, the head 1 is configured so that the diameter D [μm] of the nozzle 12N and the natural frequency Fr [kHz] of the individual channel 12B satisfy Expression 2 as follows. By causing the diameter D [μm] of the nozzle 12N and the natural frequency Fr [kHz] of the individual channel 12B to satisfy Expression 2, it is possible to eject the ink droplet in the amount V (4 pl or more) which is sufficient for a recording in a case that the recording resolution is 1200 dpi or more.

$$D \geq 0.050 \times Fr + 8. 5 \qquad Expression 2$$

Furthermore, in the present embodiment, an ejecting initial velocity of the ink droplet from the nozzle 12N is made to be 7 m/s or more. The term “ejecting initial velocity” is a velocity in a case that a meniscus of the nozzle 12N is separated from the nozzle 12N and flies. In order to make the ejecting initial velocity to be 7 m/s or more, a waveform and a driving potential of the driving signal, which is generated by the driver IC 14 through the control by the controller 5, are adjusted.

As described above, in the present embodiment, the diameter D [μm] of the nozzle 12N and the natural frequency Fr [kHz] of the individual channel 12B satisfy Expression 1 and Expression 2 as described above. Expression 1 is a requirement for not causing any linking of the ink droplets in the case that the driving frequency is the high frequency of 50 kHz or more, and for causing the ink droplets to be ejected stably. Expression 2 is a requirement for causing the ink droplet in the amount V which is sufficient for the recording to be ejected. Thus, according to the present embodiment, it is possible to eject the liquid droplet in the amount sufficient for the recording at the high driving frequency.

The recording resolution is 1200 dpi or more. In this case, a high quality image can be realized. Further, by satisfying Expression 2, it is possible to eject the liquid droplet in the amount V (4 pl or more) which is sufficient for the recording in the recording resolution of 1200 dpi or more.

The piezoelectric element 13X is the thin film piezoelectric element. Since the thickness T of the thin film piezoelectric element is small, the thin film piezoelectric element is easily deformable and is sufficiently deformable even in a case that the pressure chamber 12P is small. Further, since the thin film piezoelectric element having a small thickness is easily deformable, it is possible to deform the piezoelectric element 13X sufficiently with a low driving voltage.

The thickness T of the thin film piezoelectric element is 1.5 μm or less. In this case, it is possible to realize the above-described effect that the thin film piezoelectric element 13X is easily deformable even in a case that the pressure chamber 12P is small; and that it is possible to sufficiently deform the piezoelectric element 13X with the low driving voltage can be realized, in a more ensured manner.

The width W of the pressure chamber 12P is 70 μm or less. In this case, owning to the small volume of the pressure chamber 12P, the natural frequency Fr of the individual channel 12B is increased, thereby making it possible to satisfy Expression 1 easily.

The length L of the pressure chamber 12P is 550 μm or less. In this case, owning to the small volume of the pressure chamber 12P, the natural frequency Fr of the individual channel 12B is increased, thereby making it possible to satisfy Expression 1 easily.

In a case that the initial ejecting velocity of the ink droplet from the nozzle 12N is less than 7 m/s, the flying direction of the ink droplet is more likely to be deviated from a desired direction, due to the influence of an air current generated accompanying with the conveyance of the paper sheet 9, due to which the landing position of the ink droplet is more likely to be deviated from a desired position. In view of this, in the present embodiment, the initial ejecting velocity is 7 m/s or more, which in turn stabilizes the landing position.

In a case that the diameter D of the nozzle 12P exceeds 25 μm, the amount V of the ink droplet ejected from the nozzle 12N becomes excessive. In a case that the amount V becomes excessive, the supply of the ink to the nozzle 12N might become unstable. Further, in such a case, the ink droplet wets and spreads on the paper sheet 9 to a great extent, which in turn might deteriorate the image quality. In view of this, in the present embodiment, the diameter D of the nozzle 12N is made to be 25 μm or less, which in turn prevents the amount V of the ink droplet ejected from the nozzle 12N from becoming excessive. Owing to this, it is possible to supply the ink stably to the nozzle 12N, and to prevent any lowering in the image quality which would be otherwise caused due to the wetting and spreading of the ink droplet.

As depicted in FIG. 3, the nozzles 12N are arranged at the pitch P which is 300 dpi or more per row. With this, the size of the channel member 12 can be made small and the high image quality can be obtained.

### Second Embodiment

The head 1 of the first embodiment has the recording resolution of 1200 dpi×1200 dpi in the paper width direction and the conveying direction. With respect to this, a head 201 of a second embodiment has a recording resolution of 600 dpi×600 dpi in the paper width direction and the conveying direction.

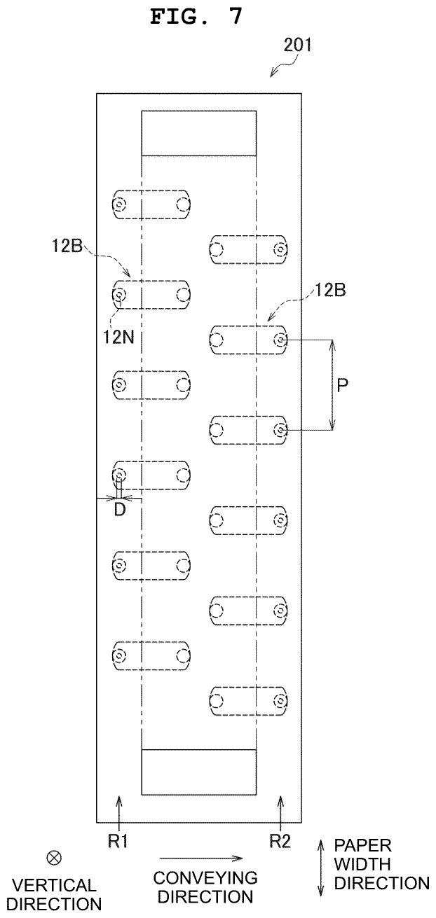

As depicted in FIG. 7, in the head 210 of the second embodiment, a plurality of nozzles 12N are arranged in a staggered manner in the paper width direction and construct two nozzle rows R1 and R2. Each of the nozzle rows R1 and R2 is constructed of nozzles 12N, of the plurality of nozzles 12N, which are aligned in the paper width direction.

In each of the nozzle rows R1 and R2, the nozzles 12N are arranged in the paper width direction at a pitch P which is 300 dpi or more. In the present embodiment, a recording resolution in each of the nozzle rows R1 and R2 is 300 dpi, and the pitch P is approximately 84 μm in each of the nozzle rows R1 and R2.

In the two nozzle rows R1 and R2, the positions of the plurality of nozzles 12N in the paper width direction are shifted by half the pitch P. With this, in a case that the recording resolution in each of the nozzle rows R1 and R2 is 300 dpi, a recording resolution of 600 dpi is realized by the two nozzle rows R1 and R2.

In order to record an image of satisfactory quality in a case that the recording resolution is 600 dpi or more, it is required to eject an ink droplet of which amount is approximately 6 pl.

In view of the foregoing, in the present embodiment, the head 1 is configured so that the diameter D [μm] of the nozzle 12N and the natural frequency Fr [kHz] of the individual channel 12B satisfy Expression 3 as follows. By causing the diameter D [μm] of the nozzle 12N and the natural frequency Fr [kHz] of the individual channel 12B to satisfy Expression 3, it is possible to eject the ink droplet in the amount V (6 pl or more) which is sufficient for the recording in a case that the recording resolution is 600 dpi or more, as explained above regarding the straight line L3 of FIG. 6.

$$D \geq 0.055 \times Fr + 11.5 \qquad Expression 3$$

As described above, in the present embodiment, the diameter D [μm] of the nozzle 12N and the natural frequency Fr [kHz] of the individual channel 12B further satisfy Expression 3 as described above, in addition to Expressions 1 and 2 as described in the foregoing. With this, it is possible to eject the ink droplet in the amount V (6 pl or more) which is sufficient for the recording.

The recording resolution is 600 dpi or more. In this case, a high quality image can be realized. Further, by satisfying Expression 3, it is possible to eject the liquid droplet in the amount V (6 pl or more) which is sufficient for the recording in the recording resolution of 600 dpi or more.

The recording resolution of 600 dpi×600 dpi. In this case, the diameter D [μm] of the nozzle 12N and the natural frequency Fr [kHz] of the individual channel 12B satisfy Expression 3 as descried above, thereby making it possible to eject the liquid droplet in the amount V (6 pl or more) which is sufficient for the recording in the recording resolution of 600 dpi×600 dpi.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above-described embodiments, although the electrode constructing the piezoelectric element has a two-layered structure including the individual electrodes and the common electrode, the electrode may have a three-layered structure. The term “three-layered structure” means, for example, a structure including a driving electrode to which a high potential and a low potential are selectively applied, a high potential electrode maintained at the high potential and a low potential electrode maintained at the low potential.

The kind of the head is not limited to being the line system, and may be a serial system.

The object of ejection of the liquid droplets is not limited to being the paper sheet (sheet, paper), and may be, for example, cloth or fabric, a substrate or plastic, etc.

The liquid droplet ejected from the nozzle is not limited to the ink droplet. The liquid droplet may be, for example, a liquid droplet of a treatment liquid which agglutinates or precipitates a component in the ink.

The present disclosure is not limited to being applicable to the printer, and is applicable also to facsimiles, copy machines, multifunction peripherals, etc. Further, the present disclosure is applicable also to a liquid droplet ejecting head used for any other application than the recording of an image. For example, the present disclosure is applicable to a liquid droplet ejecting head which forms an electroconductive pattern by ejecting an electroconductive liquid on a substrate.

What is claimed is:

1. A liquid droplet ejecting head comprising:
a channel member including a channel including a nozzle and a pressure chamber communicating with the nozzle; and
a piezoelectric element arranged on the channel member and configured to apply a pressure to a liquid inside the pressure chamber so as to eject a liquid droplet of the liquid from the nozzle, wherein
a diameter D [μm] of the nozzle and a natural frequency Fr [kHz] of the channel satisfy Expressions 1 and 2 as follows:
$$D \leq - 2.25 \times 1 {0}^{- 8} \times {Fr}^{4} + 2.11 \times 1 {0}^{- 5} \times {Fr}^{3} - 7.6 \times 1 {0}^{- 3} \times {Fr}^{2} + 1.32 \times Fr - 62.9 \qquad Expression 1$$
$$D \geq 0. 050 \times Fr + 8. 5 . \qquad Expression 2$$

2. The liquid droplet ejecting head according to claim 1, wherein
a resolution of an image recorded by the liquid droplet is 1200 dpi or more.

3. The liquid droplet ejecting head according to claim 1, wherein
the diameter D [μm] of the nozzle and the natural frequency Fr [kHz] of the channel satisfy Expression 3 as follows:
$$D \geq 0.0 \; 55 \times Fr + 11.5 . \qquad Expression 3$$

4. The liquid droplet ejecting head according to claim 3, wherein
a resolution of an image recorded by the liquid droplet is 600 dpi or more.

5. The liquid droplet ejecting head according to claim 4, wherein
the resolution is 600 dpi×600 dpi.

6. The liquid droplet ejecting head according to claim 1, wherein
the piezoelectric element is a thin film piezoelectric element.

7. The liquid droplet ejecting head according to claim 6, wherein
a thickness of the thin film piezoelectric element is 1.5 μm or less.

8. The liquid droplet ejecting head according to claim 1, wherein
a width of the pressure chamber is 70 μm or less.

9. The liquid droplet ejecting head according to claim 1, wherein
a length of the pressure chamber is 550 μm or less.

10. The liquid droplet ejecting head according to claim 1, wherein
an ejecting initial velocity of the liquid droplet from the nozzle is 7 m/s or more.

11. The liquid droplet ejecting head according to claim 1, wherein
the diameter D of the nozzle is 25 μm or less.

12. The liquid droplet ejecting head according to claim 1, wherein
the nozzle is one of a plurality of nozzles arranged at a pitch of 300 dpi or more per a row.
